(19) United States
(12) Patent Application Publication
(10) Pub. No.: US 2005/0200563 A1
(43) Pub. Date: Sep. 15, 2005

(54) Driving method of a plasma display panel and a plasma display device

(76) Inventors: Jin-Sung Kim, Suwon-si (KR); Woo-Joon Chung, Suwon-si (KR); Seung-Hun Chae, Suwon-si (KR); Jin-Ho Yang, Suwon-si (KR); Tae-Seong Kim, Suwon-si (KR)

Correspondence Address: CHRISTIE, PARKER & HALE, LLP, PO BOX 7068, PASADENA, CA, 91109-7068, US

(21) Appl. No.: 10/960,379

(22) Filed: Oct. 6, 2004

(30) Foreign Application Priority Data
Mar. 15, 2004 (KR) 10-2004-0017328

(51) Int. Cl. G09G 3/28

(52) U.S. Cl. 345/60

(57) ABSTRACT

A driving method of a plasma display panel. A second voltage is applied to a first electrode being selected in an order in which a plurality of first electrodes are selected, the second voltage being higher than a first voltage being applied to other first electrodes in a subfield of a first group of subfields. A fourth voltage is applied to the second electrode of a discharge cell being turned on among a plurality of discharge cells located in the first electrodes, the fourth voltage being lower than a third voltage being applied to other second electrodes. The discharge cell being turned on is selected in the subfield of the first group of subfields. Sustain discharge is performed at the selected discharge cell.

### CROSS REFERENCE TO RELATED APPLICATION

This application claims priority to and the benefit of Korea Patent Application No. 2004-17328 filed on Mar. 15, 2004 in the Korean Intellectual Property Office, the entire content of which is incorporated herein by reference.

### BACKGROUND OF THE INVENTION

(a) Field of the Invention

The present invention relates to a driving method of plasma display panel and a plasma display device.

(b) Description of the Related Art

A plasma display device using a plasma display panel (PDP) is a flat display device for displaying characters or images using plasma generated by gas discharge. Several tens to several millions of pixels are arranged in a matrix format on the plasma display panel according to the plasma display panel size.

First, the structure of the plasma display panel is described with reference to FIG. 1 and FIG. 2. As shown in FIG. 1, the plasma display panel includes two substrates 1, 6 arranged in a face-to-face relationship. On substrate 1, parallel pairs of scan electrode 4 and sustain electrode 5 are arranged, and are covered with dielectric layer 2 and protective layer 3. On substrate 6, a plurality of address electrodes 8, which are covered with insulating layer 7, are arranged. Barrier ribs 9 are formed in parallel with address electrodes 8 on insulating layer 7, which is interposed between address electrodes 8. A fluorescent material 10 is formed on the surface of insulating layer 7 and on both sides of barrier ribs 9. Glass substrates 1, 6 are arranged in a face-to-face relationship with a discharge space 11 formed therebetween, so that scan electrodes 4 and sustain electrodes 5 lie in a direction perpendicular to address electrodes 8. Discharge spaces at intersections between address electrodes 8 and the pairs of scan electrode 4 and sustain electrode 5 form discharge cells 12.

FIG. 2 shows an arrangement of electrodes in the plasma display panel. As shown in FIG. 2, electrodes of the plasma display panel are arranged with an n×m matrix structure. The plasma display panel includes a plurality of address electrodes A₁ to Aₘ arranged in a column direction, a plurality of sustain electrodes X₁ to Xₙ arranged in a row direction, and a plurality of scan electrodes Y₁ to Yₙ arranged in a row direction.

Referring now to FIG. 3, generally, the driving of the plasma display panel is performed on one field composed of a plurality of subfields having their respective weights. The gray scale can be presented by combining their weights in accordance with a combination of subfields. Each subfield is composed of a reset period, an address period, and a sustain period. The reset period is a period for erasing a condition of a wall charge formed by a previous sustain discharge, and resetting the condition of each cell so as to stably perform a next address discharge. The address period is a period for selecting cells that are turned on and those that are not turned on from the panel, and accumulating the wall charges on the turned-on cells (addressed cells). The sustain period is a period for executing a discharge for displaying images to the addressed cells.

Generally, the reset period is a period for resetting all types of discharge cells, and thus a difference between a highest voltage and a lowest voltage is set to be twice the level of a firing voltage Vf_ay between the sustain electrode and the address electrode. That is, a difference between a highest voltage, Vset, and a lowest voltage, Vnf, in the reset period is set to be more than 2 Vf_ay. Voltages between electrodes in discharge cells maintaining a stable condition under a predetermined external applying voltage are determined according to the combination of the external applying voltage and wall charge. The size of the voltages ranges from −Vf_av to Vf_ay. Thus, to generate discharge in all discharge cells, a voltage change of 2Vf_ay is required to be applied between the scan electrode and the address electrode. That is, when an external voltage of more than 2Vf_ay is applied, the external voltage is combined with the wall charge, and the voltage between electrodes because of the combined voltage can be more than Vf_ay. Thus, discharge for reset may occur in all discharge cells. However, when such reset voltage is applied to all discharge cells, discharge necessarily occurs for every subfield, even at a discharge cell that is not turned on. Thus, the screen becomes hazy when a 0 gray screen is displayed.

To prevent such a problem, a method applying the reset waveform of FIG. 3 to only one subfield among one field is suggested by Kurata et al. (U.S. Pat. No. 6,294,875). Kurata et al. discloses applying the reset waveform of FIG. 3 to only the first subfield and applying a falling waveform to other subfields. According to the method, erase discharge occurs only at discharge cells to which sustain discharge is performed in a previous subfield when a subfield only falling ramp waveform is applied. Thus, a weak discharge in a discharge cell that is not turned on during the reset period can be prevented. However, the weak discharge can not be perfectly erased, since the reset waveform of FIG. 3 is applied in one field at least one time.

Further, according to the conventional driving method, the reset period increases due to the reset waveform such as the reset waveform of FIG. 3, and the time for the address period or the sustain period is short.

### SUMMARY OF THE INVENTION

The present invention provides a plasma display device wherein discharge does not occur at discharge cells not being turned on. The present invention also provides a driving method of a plasma display panel that prevents a screen from being hazy in a black screen state. The present invention further provides a driving method that is capable of reducing a reset period in one field. The present invention also performs address discharge and reset discharge to discharge cells being turned on at the same time.

One aspect of the present invention is a driving method of a plasma display panel (PDP), the plasma display panel having a plurality of first electrodes arranged in one direction and plurality of second electrodes arranged in a direction crossed with the first electrodes and discharge cells formed at each cross area of the first electrodes and the second electrodes. The driving method includes: applying a second voltage to the first electrode being selected in an order in which the plurality of the first electrodes are selected, the second voltage being higher than a first voltage being applied to other first electrodes in a subfield of a first group of subfields; and applying a fourth voltage to the second electrode of a discharge cell being turned on among a plurality of discharge cells located in the first electrodes, the fourth voltage being lower than a third voltage being applied to other second electrodes and selecting the discharge cell being turned on in the subfield of the first group of subfields; and performing sustain discharge at the selected discharge cell in the subfield.

According to an exemplary embodiment of the present invention, an electric field occurs between the first electrode and the second electrode in a direction from the first electrode to the second electrode and discharge can occur in the electric field.

According to another exemplary embodiment of the present invention, one field includes the first group of subfields and a second group of subfields. The first group of subfields and the second group of subfields are determined by voltage applied for selecting the discharge cell being turned on. The driving method of the present invention further includes: applying a sixth voltage to the first electrode being selected in the order in which the plurality of first electrodes are selected, the sixth voltage being lower than a fifth voltage being applied to other first electrodes; and applying a eighth voltage to the second electrodes of a discharge cell being turned on among plurality of discharge cells located in the first electrodes, the eighth voltage being higher than a seventh voltage being applied to other second electrodes; selecting a discharge cell being turned on in a subfield of the second group of subfields; and performing sustain discharge at the selected discharge cell in the subfield.

According to another exemplary embodiment of the present invention, the difference between the first electrode and the second electrode is higher than a difference between the fifth voltage and the sixth voltage.

According to another exemplary embodiment of the present invention, the eighth voltage is the same voltage as the third voltage and the seventh voltage is the same voltage as the fourth voltage.

According to another exemplary embodiment of the present invention, the plasma display panel is arranged in the same direction as the first electrodes and further includes a plurality of third electrodes forming the discharge cells with the first electrodes and the second electrodes. A first sustain discharge among the sustain discharges in the subfield of the first group of subfields is fired by applying a ninth voltage to the first electrode and applying a tenth voltage to the third electrode, the tenth voltage being higher than the ninth voltage.

According to another exemplary embodiment of the present invention, the first sustain discharge among the sustain discharges in the subfield of the second group of subfields is fired by applying an eleventh voltage to the first electrode and applying a twelfth voltage to the third electrode, the twelfth voltage being lower than the eleventh voltage.

According to another exemplary embodiment of the present invention, the driving method further includes erasing a wall charge formed by sustain discharge in the previous subfield and selecting the discharge cell in the subfield of the first group of subfields.

According to another exemplary embodiment of the present invention, the driving method further includes gradually reducing the voltage of the first electrode from the ninth voltage to the tenth voltage and selecting the discharge cell in the subfield of the first group of subfields. Here, the eleventh voltage is the voltage found when the fourth voltage is subtracted from the second voltage, and the twelfth voltage is the voltage found when the voltage being applied to the second electrode is subtracted from the tenth voltage, when the tenth voltage is applied to the first electrode; and the difference between the eleventh voltage and the twelfth voltage is substantially more than twice as high as a difference between the voltage being applied to the first electrode and the voltage being applied to the third electrode for the next sustain discharge. Further, the difference between the eleventh voltage and the twelfth voltage is more than twice as high as a firing voltage between the first electrode and the second electrode.

According to another exemplary embodiment of the present invention, the first subfield in one field is in the first group of subfields. Here, the discharge cell can be necessarily turned on in the subfield of the first group of subfields, when the discharge cell is turned on at least one time in one field.

Another aspect of the present invention is a plasma display device including: a plasma display panel having a plurality of first electrodes arranged in one direction and a plurality of a second electrodes arranged in a direction crossed with the first electrodes and discharge cells formed at each cross area of the first electrodes and the second electrodes; a first driver for applying selected voltage to a first electrode being selected in the order in which a plurality of first electrodes are selected; a second driver for applying a driving voltage to a plurality of second electrodes, and selecting a discharge cell being turned on with the first electrode to which the selected voltage is applied to. Here, the selected voltage is substantially a highest voltage among the voltages being applied to the first electrode in the subfield of the first group of subfields.

Another aspect of the present invention is a plasma display device including: a plasmas display panel having a plurality of first electrodes arranged in one direction and a plurality of second electrodes arranged in a direction crossed with the first electrodes, and discharge cells formed at each cross area of the first electrodes and the second electrodes; a first driver for alternatively applying a first voltage and a second voltage to the first electrode; and a second driver for applying a third voltage that is higher than the first voltage to the second electrode, while the first voltage is applied to the first electrode, and applying a fourth voltage that is lower than the second voltage to the second electrode, while the second voltage is applied to the first electrode, and performing sustain discharge at the selected discharge cell among the discharge cells. Here, a first sustain discharge occurs by the first voltage and the third voltage in the subfield of the first group of the subfields, and the first sustain discharge occurs by the second voltage and the fourth voltage in the subfield of the second group of the subfields.

Another aspect of the present invention is a plasma display device including a plasma display panel where plurality of discharge cells are formed, and each discharge cell is formed by at least two electrodes; and a driver for dividing one field into a plurality of subfields with weights, and applying voltage to the electrodes in each subfield and displaying gray by discharging the discharge cell. Here, the discharge occurs only at the discharge cell being turned on in at least one field such that the wall charge formed in the previous field is quenched.

According to one exemplary embodiment of the present invention, one subfield is composed of a first period for resetting a discharge cell, a second period for selecting the discharge cell being turned on, and a third period for performing sustain discharge at the selected discharge cell; and the driver simultaneously operates the first period and the second period in at least one subfield.

According to one exemplary embodiment of the present invention, only a discharge cell being turned on is reset, while the first period and the second period are operated at the same time.

According to one exemplary embodiment of the present invention, the driver resets only a discharge cell in at least one subfields, the discharge cell being sustain discharged in the previous subfield.

Another aspect of the present invention is a plasma display device includes: a plasma display panel where a plurality of discharge cells are formed, and each discharge cell is formed by at least two electrodes; and a driver for dividing one field into a plurality of subfields with weights, and applying voltage to the electrodes in each subfield and displaying grays by discharging the discharge cell. Here, the driver selects a discharge cell being turned on in at least one subfield and resets only the discharge cell being turned on.

### BRIEF DESCRIPTION OF THE DRAWINGS

FIG. 1 is a partial perspective view of a panel of a plasma display panel (PDP).

FIG. 2 shows an arrangement of electrodes in the plasma display panel.

FIG. 3 shows a driving waveform of the plasma display panel according to the conventional method.

FIG. 4 shows a plasma display device according to an exemplary embodiment of the present invention.

FIG. 5 shows a driving waveform of the plasma display panel according to a first exemplary embodiment of the present invention.

FIG. 6A shows a wall charge condition shortly before an erase period and FIG. 6B shows a wall charge condition shortly after the erase period in the subfield (1SF) in FIG. 5.

FIG. 7A shows a wall charge condition formed by address discharge and FIG. 7B shows a wall charge condition formed by first sustain discharge in the subfield (1SF) in FIG. 5.

FIG. 8 shows a selection circuit connected to a scan electrode.

FIGS. 9 to 11 show driving waveforms of plasma display panels according to second to fourth exemplary embodiments.

FIGS. 12A and 12B show a falling waveform applied during an erase period or a reset period in the driving waveform in FIG. 5, according to other exemplary embodiments.

### DETAILED DESCRIPTION

The ‘wall charge’ mentioned in the present invention means a discharge formed to close each electrode on a wall (for example, dielectric layer) of a discharge cell. Further, although the wall charge is not contacted to the electrodes, the present invention describes the wall charge is “formed”, “accumulated” or “stacked” to the electrode. Further, wall voltage means a potential formed on a wall of a discharge cell by the wall charge.

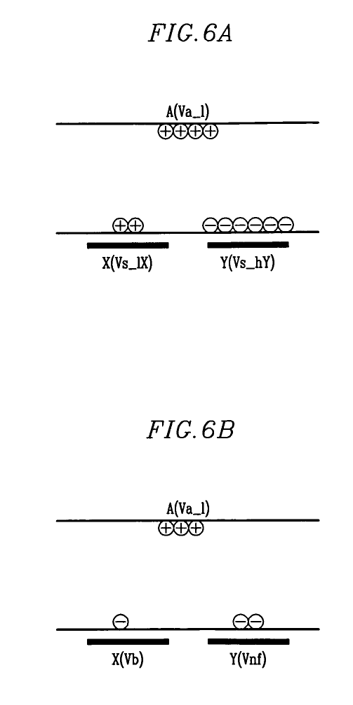

Referring now to FIG. 4 a plasma display device according to an exemplary embodiment of the present invention is shown. The plasma display device includes plasma display panel 100, controller 200, address driver 300, sustain electrode driver 400 and scan electrode driver 500.

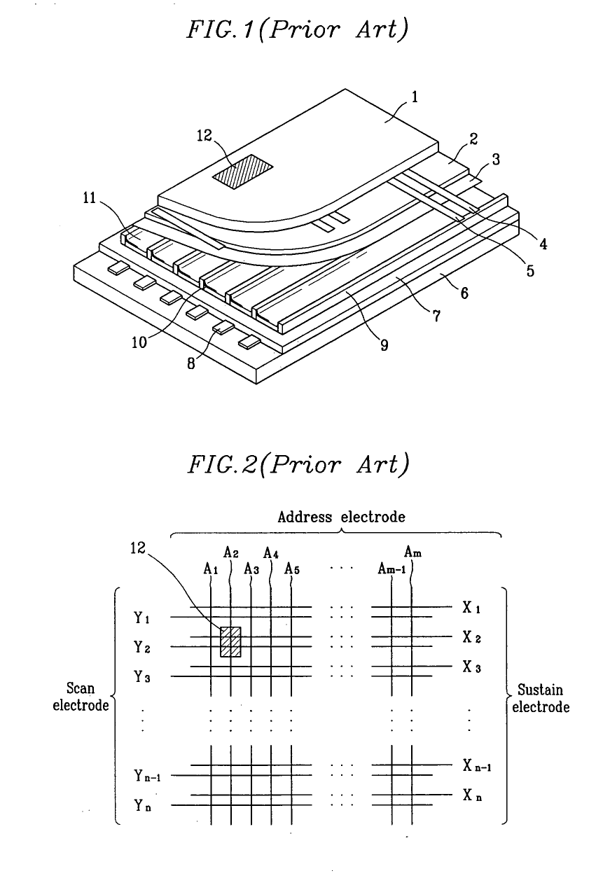

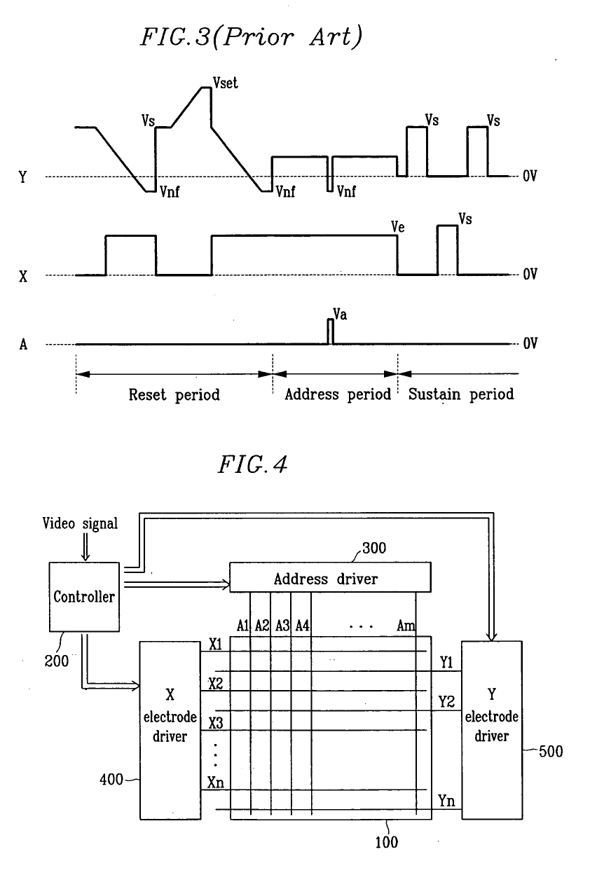

Plasma panel 100 includes a plurality of address electrodes A₁ to Aₘ arranged in a column direction, and a plurality of first electrodes Y₁ to Yₙ and a plurality of second electrodes X₁ to Xₙ arranged in a row direction. Sustain electrodes X1 to Xn are formed corresponding to each of scan electrodes Y1 to Yn. Generally, one end thereof is commonly connected to each other. Plasma display panel 100 includes a glass substrate (not shown) on which sustain electrodes X1 to Xn and scan electrodes Y1 to Yn are arranged, and a glass substrate (not shown) on which address electrodes A1 to Am are arranged. The two glass substrates are arranged in a face-to-face relationship with a discharge space formed therebetween, so that scan electrodes Y1 to Yn and sustain electrodes X1 to Xn lie in a direction perpendicular to address electrodes A1 to Am. Discharge spaces at intersections between address electrodes A1 to Am and the pairs of scan electrodes X1 to Xn and sustain electrodes Y1 to Yn form discharge cells. FIGS. 1 and 2 depict an exemplary PDP useable to practice the present invention.

Controller 200 receives an external video signal and outputs an address driving control signal, a sustain electrode driving control signal, and a sustain electrode driving control signal. Controller 200 divides one field into a plurality of subfields each having a weight for driving.

In the address period, scan electrode driver 500 applies a selected voltage to scan electrodes Y1 to Yn in accordance with the order in which the scan electrodes are selected. Address electrode driver 300 receives the address driving control signal from controller 200, and applies address voltages to each address electrodes A1 to Am for selecting discharge cells being turned on whenever a selected voltage is applied to each scan electrode. That is, the selected voltage is applied to the scan electrode of a discharge cell being turned on in an address period.

In the sustain period, sustain electrode driver 400 and scan electrode driver 500 receive control signals from controller 200, and alternatively apply voltage to sustain electrodes X1 to Xn and scan electrodes Y1 to Yn for sustain discharge. Further, scan electrode driver 500 applies a voltage to scan electrodes Y1 to Yn in the reset period or erase period for reset or erase.

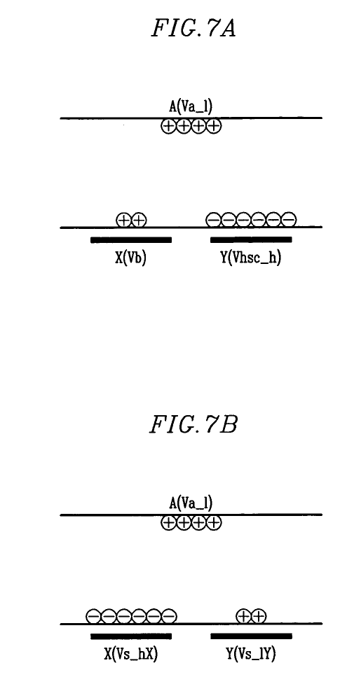

Next, the driving waveforms applied to address electrodes A1 to Am, sustain electrodes X1 to Xn, and scan electrodes Y1 to Yn in each subfield are described in detail with reference to FIGS. 5-12B. Hereinafter, one discharge cell formed by one address electrode A, one sustain electrode X, and one scan electrode Y are described as a reference example.

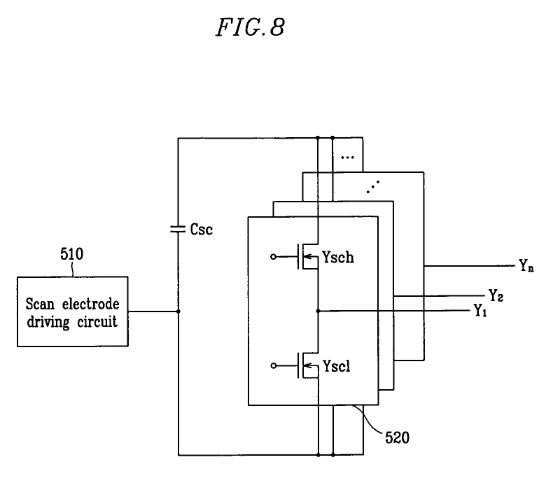

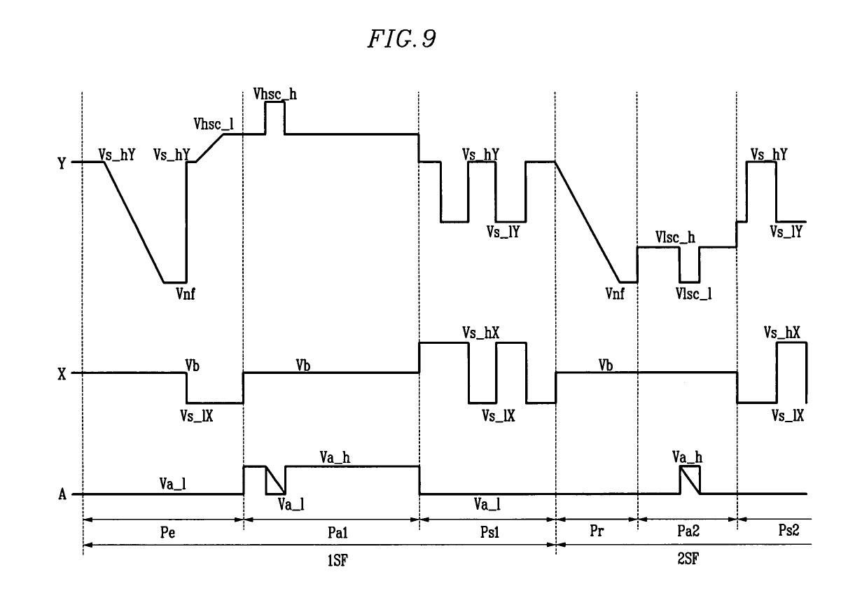

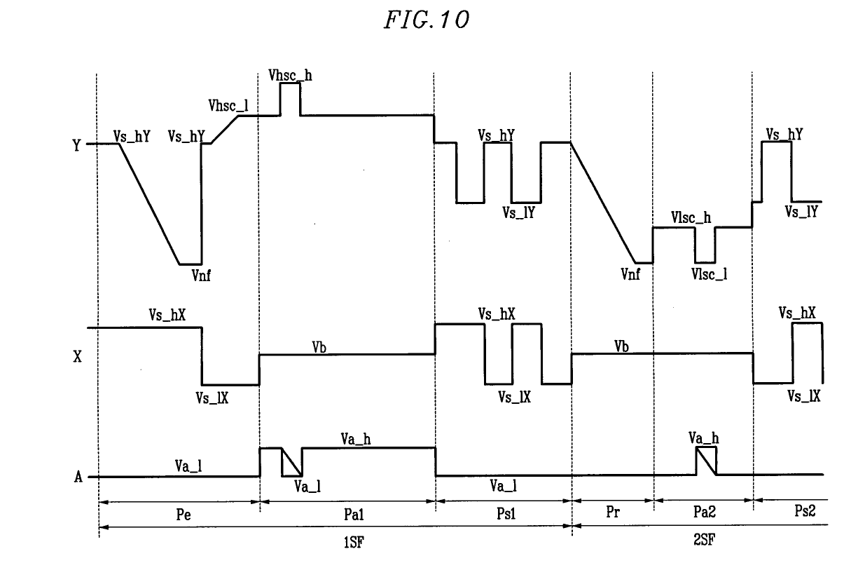

FIG. 5 shows a driving waveform of the plasma display panel according to a first exemplary embodiment of the present invention, which would be applied using the PDP described in FIG. 4. FIG. 6A shows a wall charge condition shortly before the erase period, and FIG. 6B shows a wall charge condition shortly after the erase period in subfield 1SF in FIG. 5. FIG. 7A shows a wall charge condition formed by address discharge and FIG. 7B shows a wall charge condition formed by a first sustain discharge in subfield 1SF in FIG. 5. FIG. 8 shows a selection circuit connected to a scan electrode.

As shown in FIG. 5, in the driving waveform according to the first exemplary embodiment of the present invention, one field is composed of a plurality of subfields. At least one subfield (e.g., subfield 1SF in FIG. 5) among each field has a driving waveform different from other subfields. For example, when one field is composed of 8 subfields, at least one subfield 1SF may be composed of erase period Pe, address period Pa1, and sustain period Ps1.

First, subfield 1SF composed of erase period Pe, address period Pa1, and sustain period Ps1 is described. Erase period Pe of the subfield is a period for performing erasure on the discharge cell to which a sustain discharge is performed in a previous sustain period Ps2. At the end point of a sustain period Ps2 of a previous subfield 8SF, high voltage Vs_hY is applied to the scan electrode and low voltage Vs_lX is applied to the sustain electrode. At this time, sustain discharge is performed at an addressed discharge cell in the address period Pa2 of the previous subfield 8SF. When the sustain discharge is finished, a (−) wall charge is accumulated to scan electrode Y, a (+) wall charge is accumulated to sustain electrode X, and a (+) wall charge is accumulated to address electrode A as shown in FIG. 6A. The address discharge and sustain discharge do not occur at discharge cells which are not addressed in the address period Pa2 of the previous subfield 8SF. Thus, a wall charge condition established before the address period of the previous subfield is maintained.

In erase period Pe, the voltage of scan electrode Y is gradually reduced from Vs_hY to Vnf, in a condition such that sustain electrode X is biased with Vb voltage and address electrode A is biased with Va_l voltage. At this time, a difference between the Vs_hX voltage and the Vnf voltage is regarded as a voltage capable of discharge, when the difference is combined with the wall voltage by the wall charge formed in the previous sustain discharge in the sustain period Ps2 of the previous subfield 8SF. Then, the wall charge formed by the sustain discharge in the sustain period Ps2 of the previous subfield 8SF is erased with a weak discharge as shown in FIG. 6B. However, in the discharge cell in which the sustain discharge did not occur in the previous subfield 8SF, the wall charge is not erased.

Erase period Pe can be understood to be included in the subfield 8SF of the previous field, since erase period Pe is the period next to sustain period Ps2 of subfield 8SF of the previous field. That is, when the sustain discharge occurs in subfield 8SF of the previous field, the erase discharge occurs in the erase period but when the sustain discharge did not occur in subfield 8SF of the previous field, the erase discharge does not occur in the erase period.

Next, in address period Pa1, the voltage of sustain electrode X is maintained at Vb voltage which is lower than Vhsc_h voltage. Then the Vhsc_h voltage is applied to scan electrode Y and the Va_{—}1 voltage is applied to address electrode A for selecting the discharge cell being turned on. At this time, the sustain electrode being not selected is biased with Vs_hY voltage that is lower than Vhsc_h voltage, and the Va_h voltage that is higher than Va_l voltage is applied to the address electrode of the discharge cell that is not turned on.

The Vhsc_h voltage is applied to the scan electrode (Y1 of FIG. 4) of the first row and the Va_{—}1 voltage that is lower than the Vhsc_h voltage is simultaneously applied to the address electrode that is located at the discharge cell that is desired to be displayed. At this time, the difference between the Vhsc_h voltage and the Va_{—}1 voltage is established to be higher than the firing voltage between address electrode A and scan electrode Y, when the difference is combined with the wall charge formed in erase period Pe. Then, an electric field from scan electrode Y to address electrode A is formed, and discharge occurs. Scan electrode Y is the electrode of the first row to which the Vlsc_h voltage is applied, and address electrode A is the electrode to which the Va_l voltage is applied. Then, discharge occurs between the scan electrode and the sustain electrode close to the scan electrode. Thus, a (−) wall charge is formed at scan electrode Y, and a (+) wall charge is formed at the address electrode A and sustain electrode X as shown in FIG. 7A.

Subsequently, the Va_{—}1 voltage is applied to the address electrode located at the discharge cell that is desired to be displayed, while the Vhsc_h voltage is applied to the scan electrode (Y2 of FIG. 4) of the second row. Then, the address discharge occurs at the discharge cell formed by address electrode A and scan electrode Y. Thus, a wall charge is formed as shown in FIG. 7A. In the same manner, the Va_{—}1 voltage is applied to the address electrode located at the discharge cell that is desired to be displayed, while the Vhsc_h voltage is applied to the scan electrodes of the other rows in order. Thus, a wall charge is formed.

When the (−) wall charge is formed at scan electrode Y and (+) wall charge is formed at sustain electrode X by the address discharge, the Vs_lY voltage is applied to scan electrode Y and the Vs_hX voltage that is higher than the Vs_lY voltage is applied to sustain electrode X. At this time, the difference between the Vhsc_h voltage and the Va_{—}1 voltage (Vs_hx−Vs_lY) is established to be higher than the firing voltage, when the difference is combined with the wall voltage Vw1 by the wall charge formed at scan electrode Y and sustain electrode X. Then, discharge occurs between scan electrode and the sustain electrode at the discharge cell that discharged in address period Pa1. Then, a (+) wall charge is accumulated to scan electrode Y, a (−) wall charge is accumulated to sustain electrode X, and a (+) wall charge is accumulated to the address electrode at the discharge cell in which sustain discharge occurred, as shown in FIG. 7B.

Next, the Vs_hY voltage is applied to scan electrode Y and the Vs_lX voltage that is lower than the Vs_hY voltage is applied to sustain electrode X. At this time, the difference between the Vs_hY voltage and the Vs_lX voltage is established to be higher than the firing voltage, when the difference is combined with the wall voltage Vw2 by the wall charge formed by the previous sustain discharge. Then sustain discharge occurs between scan electrode Y and sustain electrode X of the discharge cell where the previous sustain discharge occurred. At this time, the difference between Vs_hX and Vs_lY is substantially the same as the difference between Vs_hY and Vs_lX. If the Vs_hX voltage is set to be the same level as the Vs_hY voltage and the Vs_lX voltage is set to be the same level as the Vs_lY voltage, the number of power sources can be reduced.

That is, the above process includes applying the Vs_lY voltage to scan electrode Y and applying the Vs_hX voltage to the sustain electrode and then applying the Vs_hY voltage to the scan electrode and applying the Vs_lX voltage to the sustain electrode. The above process can be repeated a predetermined number of times corresponding to the weight of the subfields for maintaining the sustain discharge. Then sustain period Ps1 can be finished after the Vs_hY voltage is applied to scan electrode Y and the Vs_lX voltage is applied to the sustain electrode.

Next, in reset period Pr composed of the reset period Pr, address period Pa2, and sustain period Ps2, the voltage of scan electrode Y is gradually reduced from the Vs_hY voltage to the Vnf voltage such that sustain electrode X is biased with the Vb voltage, and the address electrode is biased with the Va_l voltage. At this time, in the discharge cell where the sustain discharge did not occur in previous subfield 1SF, a wall charge established by the final voltage of erase period Pe in previous subfield 1SF is maintained. Thus, erase discharge does not occur since the final voltages Vnf, Vb, and Va_l of the reset period of present subfield 2SF are the same as those of erase period Pe. However, in the discharge cell where the sustain discharge occurred in previous subfield 1SF, the voltage of scan electrode Y gradually falls. Thus, the wall charge is erased by the weak discharge which occurred when the combination of the scan voltage and the wall voltage (referring to FIG. 7B) is higher than the firing voltage. The wall charge is shown in FIG. 6B.

Subsequently, the Vlsc_l voltage that is lower than Vb is applied to scan electrode Y, and Va_h that is higher than Vlsc_l is applied to the address electrode in address period Pa2 for selecting a discharge cell that is turned on such that the voltage of the sustain is maintained at Vb voltage. However, the scan electrode being not selected is biased with Vlsc_h higher than Vlsc_l, and Va_l lower than Va_h is applied to the address electrode of the discharge cell that is not turned on.

Vlsc_l voltage is applied to the scan electrode (Y1 of FIG. 4) of the first row and Va_h voltage is simultaneously applied to the address electrode located at the discharge cell that is desired to be displayed. FIG. 5 discloses that the Vlsc_l voltage is the same level as the Vnf voltage in the reset period. Then, an electric field from address electrode A to scan electrode Y is formed and discharge occurs. Address electrode A is the electrode to which the Va_h voltage is applied, and scan electrode Y is the electrode of the first row to which the Vlsc_l voltage is applied. Then, discharge occurs between scan electrode Y and sustain electrode X close to the scan electrode. Thus, a (+) wall charge is formed at scan electrode Y, and (−) wall charges are formed at address electrode A and sustain electrode X.

Subsequently, the Va_h voltage is applied to the address electrode located at the discharge cell that is desired to be displayed while the Vhsc_l voltage is applied to the scan electrode (Y2 of FIG. 4) of the second low. Then, the address discharge occurs at the discharge cell formed by address electrode A and the scan electrode. Thus, the wall charge is formed on the discharge cell as shown in FIG. 7a. In the same manner, the Va_h voltage is applied to the address electrode located at the discharge cell that is desired to be displayed, while the Vhsc_l voltage is applied to the scan electrodes of the other rows in order. Thus, the wall charge is formed.

When the (+) wall charge is formed at scan electrode Y and the (−) wall charge is formed at sustain electrode X by the address discharge of subfield 2SF, the Vs_hY voltage is applied to scan electrode Y and the Vs_lX voltage that is lower than the Vs_hY voltage is applied to sustain electrode X. Then, discharge occurs between scan electrode Y and sustain electrode X at the discharge cell at which discharge occurred in address period Pa2. Then, a (−) wall charge is formed at scan electrode Y and a (+) wall charge is formed at sustain electrode X as shown in FIG. 7A.

Next, the Vs_lY voltage is applied to scan electrode Y, and the Vs_hX voltage that is higher than the Vs_lY voltage is applied to sustain electrode X. Then sustain discharge occurs between scan electrode Y and sustain electrode X of the discharge cell where the previous sustain discharge occurred. That is, the above process includes applying the Vs_hY voltage to scan electrode Y and applying the Vs_lX voltage to the sustain electrode; and then applying the Vs_lY voltage to the scan electrode and applying the Vs_hX voltage to the sustain electrode. The above process can be repeated a predetermined number of times corresponding to the weight of the subfields for maintaining the sustain discharge. Then sustain period Ps2 can be finished after the Vs_hY voltage is applied to scan electrode Y and the Vs_lX voltage is applied to the sustain electrode.

Next, in the other subfields 3SF-8SF including reset a period, address period, and the sustain period, the same waveform as that of subfield 2SF is applied. However, the number of pulses repeating in the sustain period depends on the weight of subfields 3SF-8SF. Then, in these subfields, a wall charge established in the reset period of the previous subfield is maintained in the discharge cell in which sustain discharge did not occur. Thus, the erase discharge does not occur in reset period Pr of the present subfield.

If the subfields are designed as described above, a discharge does not occur at a discharge cell that is not turned on in one field, that is, a discharge cell corresponding to 0 gray. Thus, the hazy black screen can be prevented, since the discharge does not occur at the area when all grays of discharge cells are 0 at certain areas.

Further, the difference between Vhsc_h voltage and Vnf can be set to be more than twice as high as the firing voltage Vf_ay between the address electrode A and scan electrode Y. The Vhsc_h voltage is a voltage applied to scan electrode Y in address period Pa1, and the Vnf voltage is a voltage applied to scan electrode Y in the reset period.

Then, since the Vnf voltage and the Vhsc_h voltage are applied to scan electrode Y of the discharge cell that is turned on such that the Va_l voltage is applied to address electrode A in subfield 1SF, a difference of the voltages applied to scan electrode Y and address electrode A, Vhsc_h−Vnf, can be set to be more than twice as high as the firing voltage Vf_ay. However, to prevent discharge between the scan electrode and the address electrode to which the Va_h voltage is applied, the difference between Vhsc_h voltage and Va_h voltage is set to be lower than 2 Vf_ay.

When Vs_lx, Vs_lY, and Va voltages are assumed to be 0V, the Vs_hY voltage being applied to scan electrode Y or the Vs_lY voltage being applied to sustain electrode X is set to be lower than the Vf_ay voltage, in order to prevent discharge from occurring between the address electrode and the scan electrode at the discharge cell in the sustain period where the address discharge did not occur in the address period. That is, when Vs_lx and Vs_lY voltages are assumed to be 0V, Vs_hY and Vs_hX voltages are lower than the Vf_ay voltage. Thus, when Vs_lx and Vs_lY voltages are not 0V, the Vs_hY−Vs_lX voltage and the Vs_hX−Vs_lY voltage are lower than the Vf_ay voltage. Thus, a difference between the Vhsc_h voltage and the Vnf voltage is set to be more than twice as high as the voltage difference Vs_hY−Vs_lX between scan electrode Y and sustain electrode X in the sustain period.

Further, in the final voltage of erase period Pe in subfield 1SF, when the wall voltage formed at address electrode A and scan electrode Y is combined with the voltage difference Vnf−Va_l between the Vnf voltage applied to the scan electrode and the Va_{—}1 voltage applied to address electrode A, the combined voltage is around −Vf_ay. At this time, when the difference between the Vhsc_h voltage and the Vnf voltage applied to scan electrode Y in the address period is 2Vf_ay, the voltage combined of the applied voltage and the wall voltage becomes the Vf_ay voltage at the discharge cell where the Vhsc_h voltage is applied to address electrode A and the Va_l voltage is applied to scan electrode Y. Thus, discharge can occur at the discharge cell. However, at the other discharge cells, discharge cannot occur since the combined voltage is lower than the Vf_ay voltage. That is, the address discharge occurs only at the discharge cell being turned on.

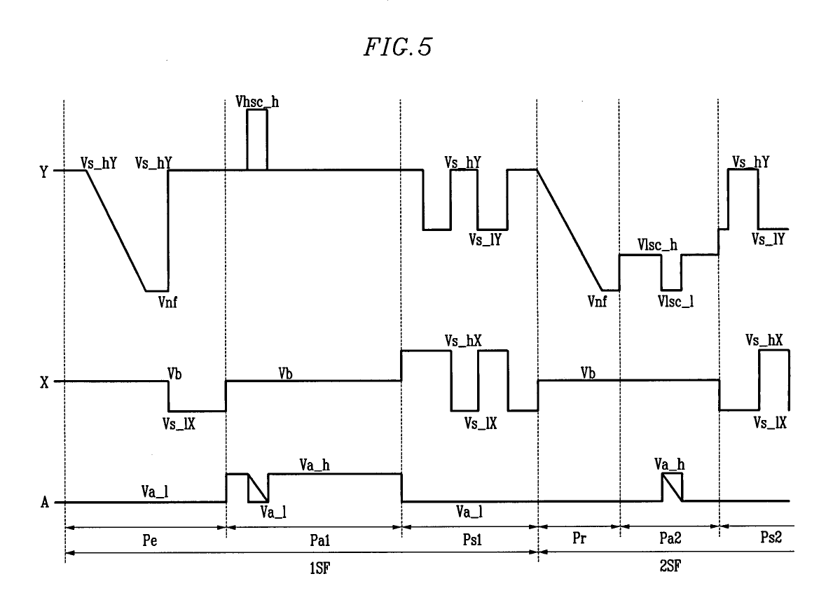

Further, when a difference between the scan electrode and address electrode A is more than twice as high as the firing voltage, the discharge cell can be initialized when the address discharge occurs at the discharge cell where the Vhsc_h voltage is applied to scan electrode Y and the Va_l voltage is applied to address electrode A. That is, the address discharge in subfield 1SF can perform a reset function of the reset period in the conventional waveform shown in FIG. 3, and the reset is performed at only the discharge cell being turned on in subfield 1SF. And, when the subfield is designed so that the discharge cell is turned on at subfield 1SF of one field, the reset function and address function are performed in the address period of subfield 1SF at the discharge cell with at least one gray, and the reset function and address function are not performed at the discharge cell with 0 gray (being not turned on for one field). Using the same principle, the subfield with a low weight is designed according to the case of subfield 1SF. The subfield can be set so that discharge must occur, even when a gray is required to be displayed. That is, subfields with weights 1, 2, and 4 are constructed according to subfield 1SF, the subfields can be constructed so that gray is displayed in subfields including subfields with weights 1, 2, and 4 even when a gray is required to be displayed.

And according to the first exemplary embodiment of the present invention, in address period Pa1 of subfield 1SF, the Va_l voltage is applied to the address electrode of the discharge cell being turned on, but the Va_h voltage is applied to the address electrode of the discharge cell that is not turned on. On the contrary, in an address period Pa2 of subfields 2SF-8SF, the Va_h voltage is applied to the address electrode of the discharge cell being turned on, but the Va_l voltage is applied to the address electrode of the discharge cell that is not turned on. Thus, an IC control signal alternatively applying the Va_h voltage or the Va_l to the address electrode is reversely used at the subfield 1SF and subfields 2SF-8SF. That is, the address electrode can be driven by the same address IC.

Further, according to the first exemplary embodiment of the present invention, the Vhsc_h voltage is applied to the scan electrode in order, such that scan electrode Y is biased with the Vs_hY voltage, in address period Pa 1 of subfield 1SF. Generally, IC typed selection circuits 520 are connected to scan electrodes Y1 to Yn for selecting a plurality of scan electrodes Y1 to Yn in order as shown in FIG. 8. Selection circuit 520 includes two switches Ysch and Yscl, and two voltages can be applied to the scan electrode in accordance with the turn-on of each switch. Capacitor Csc in which the predetermined voltage ΔVsc is charged is connected to both ends of selection circuit 520. Scan electrode driving circuit 510 for applying the driving waveform shown in FIG. 5 to the scan electrode is connected to one end of capacitor Csc.

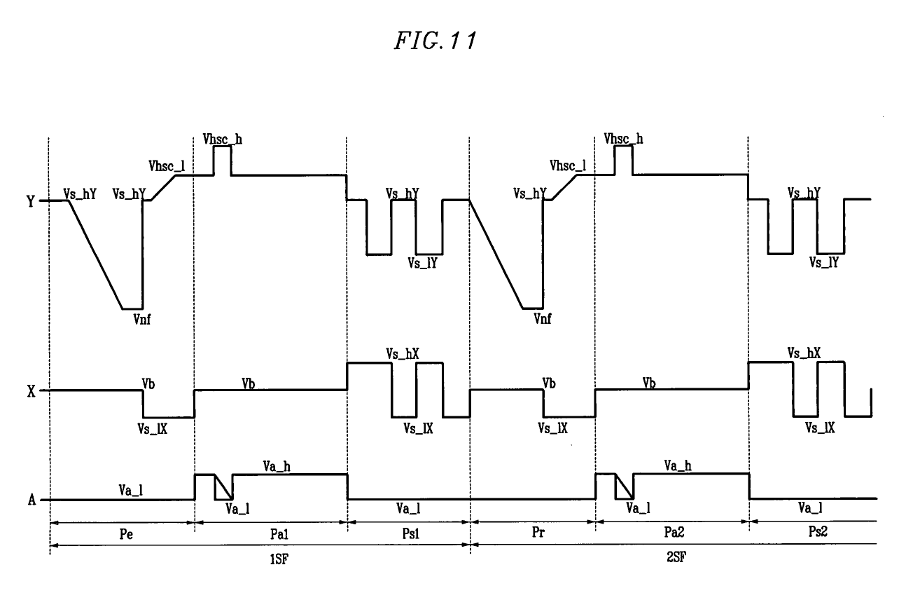

Selection circuit 520 combines the voltage applied from scan electrode driving circuit 510 and voltage Δ Vsc charged in capacitor Csc, and selectively applies the combined voltage to the scan electrode. However, when the difference between the Vhsc_h voltage and the Vs_hY voltage in subfield 1SF is higher than the difference between the Vlsc_h voltage and the Vlsc_l voltage, capacitors for charging voltage corresponding to the difference are required. Also, the switches for selecting the capacitors are further required. Hereinafter, an exemplary embodiment capable of the same capacitors in the subfields are described with reference to FIG. 9. FIG. 9 shows a driving waveform of a plasma display panel according to a second exemplary embodiment of the present invention.

As shown in FIG. 9, the driving waveform according to a second exemplary embodiment of the present invention, which would be applied using the PDP described in FIG. 4, is the same as the driving waveform of FIG. 5 except that the Vhsc_l voltage is applied to scan electrode Y that is not selected in address period Pa1 of subfield 1SF. That is, the second exemplary embodiment applies the Vhsc_h voltage to scan electrode Y selected in order such that scan electrode Y is biased with the Vhsc_l voltage. At this time, since the discharge does not occur when the voltage of scan electrode Y is changed from the Vs_hY voltage to the Vhsc_l voltage, the voltage of the sustain electrode can be biased with the Vs_lX voltage and can be maintained at Vb.

Further, if the voltage of scan electrode Y is gradually changed from the Vs_hY voltage of erase period Pe to the Vhsc_l voltage as in FIG. 9, erroneous discharge can be reduced to weak discharge, when the discharge cells are unstable. FIG. 9 shows that the voltage of the scan electrode gradually rises as a ramp type from the Vs_hY voltage to the Vhsc_l voltage. However, the voltage of the scan electrode can be gradually changed by using the other type of waveform. Further, the voltage of the scan electrode can be rapidly increased from the Vs_hY voltage to the Vhsc_l voltage.

In the waveform of FIG. 9, when the Vhsc_l voltage is set so that the difference between the Vhsc_h voltage and the Vhsc_l voltage is the same as the difference between the Vlsc_h voltage and the Vlsc_l voltage, the same capacitor can be used in all subfields. That is, when voltage A Vsc charged in capacitor Csc in FIG. 8 is set to be the difference between the Vhsc_h voltage and the Vhsc_l voltage, scan electrode driving circuit 520 supplies the Vhsc_l voltage in address period Pa1 and supplies the Vlsc_l voltage in address period Pa2. Switch Yscl of selection circuit 520 is turned on and the Vhsc_l voltage is applied from scan electrode driving circuit 510 in the scan electrode that is not selected in address period Pa1 of subfield 1SF. However, switch Ysch of selection circuit 520 is turned on and the Vhsc_l voltage is combined with the ΔVsc voltage of capacitor Csc, and the combined voltage Vhsc_h is applied to the scan electrode being selected. Further, switch Ysch of selection circuit 520 is turned on and the Vhsc_l voltage is combined with the Δ Vsc voltage of capacitor Csc, and the combined voltage Vhsc_h is applied to the scan electrode that is not selected in address period Pa2 of subfields 2SF-8SF. However, switch Ysc_l is turned on, and the Vhsc_l voltage is applied to the scan electrode being selected.

The exemplary embodiment of the present invention discloses that the reset voltage is the same as the voltage being applied to scan electrode Y and sustain electrode X in erase period Pe. However, the reset voltage can be set to be different from the voltage. To erase more wall charge accumulated at scan electrode Y and sustain electrode A in erase period Pe, the voltage of sustain electrode X can be biased with the Vs_Xh voltage that is higher than Vb, as shown in FIG. 10. Further, the exemplary embodiment of the present invention discloses that the Vnf voltage is the same as the Vscl voltage. However, both voltages can be different. Further, the voltage level being applied to scan electrode Y, sustain electrode X, and address electrode A can be changed, such that the difference between scan electrode Y and address electrode A and the difference between scan electrode Y and sustain electrode X are substantially the same as the first and second exemplary embodiments.

Further, the exemplary embodiment of the present invention discloses that one field includes one subfield such as subfield 1SF composed of erase period Pe, address period Pa1, and sustain period Ps1. However, at least two of such subfields can be used as shown in FIG. 11, and all subfields can be embodied as subfield 1SF. Further, subfield 1SF can be a middle subfield instead of the first subfield.

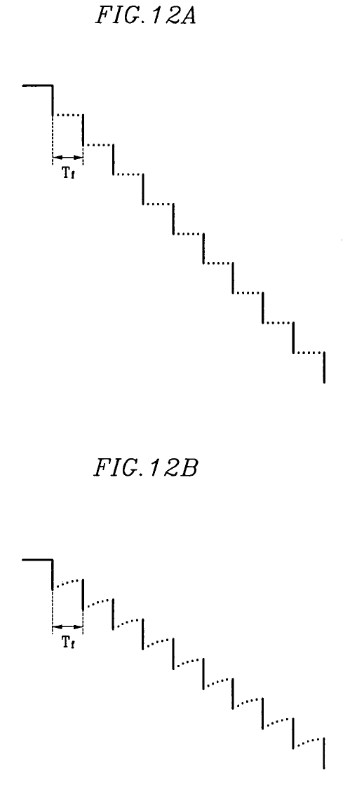

FIG. 5, FIG. 9, FIG. 10, and FIG. 11 disclose that the voltage of scan electrode Y falls as a ramp-type in the erase period or reset period. However, the voltage of scan electrode Y can fall as a curve. Further, FIG. 12A and FIG. 12B disclose that the voltage of the scan electrode gradually falls by repeating the process. The process includes reducing the voltage of the scan electrode by the predetermined amount of voltage and then floating the voltage of the scan electrode during the predetermined time. The voltage of the scan electrode can gradually fall by repeating the above process. Hereinafter, the waveform is described with reference to FIGS. 12A and 12B.

FIGS. 12A and 12B show a falling waveform applied during an erase period or a reset period in the driving waveform in FIG. 5, according to another exemplary embodiment. FIG. 12A shows the falling waveform when discharge did not occur, and FIG. 12B shows the falling waveform when discharge occurred.

As shown in FIG. 12A, the voltage being applied to scan electrode Y falls by the predetermined amount of voltage and then the voltage being applied to the scan electrode is cut during Tf period to float the scan electrode. Then, the above process is repeated.

Then the process is repeated so that the difference between the voltage (Vb of FIG. 5) of sustain electrode X and the voltage of the scan electrode becomes higher than the firing voltage. The discharge occurs between sustain electrode X and scan electrode Y. Then, when the discharge occurs between sustain electrode X and scan electrode Y, and scan electrode Y is floated, the voltage of scan electrode Y is changed according to the amount of the wall charge, since no charge is inputted from an external power source. Thus, the change of the wall charge directly reduces the internal voltage of the discharge space (discharge cell), and the discharge is quenched by a small change of the wall charge. Further, when the internal voltage of the discharge is reduced, the voltage of the scan electrode floated increases by a predetermined amount of voltage v as shown in FIG. 12B, since the sustain electrode is maintained at Ve voltage.

When the discharge is allowed to be occurred by the reduction of the voltage in scan electrode Y, the wall charge formed at sustain electrode X and scan electrode Y is reduced and the internal voltage is rapidly reduced. Thus, strong discharge quenching occurs in the discharge space. Then, when the discharge is allowed to occur by the reduction of the voltage again in scan electrode Y and scan electrode Y is floated, the internal voltage is reduced and strong discharge quenching occurs in the discharge space as above. The process including reducing the voltage of scan electrode Y, and floating scan electrode Y is repeated a predetermined number of times until the desired amount of wall charge is accumulated at sustain electrode X and scan electrode Y.

In the ramp waveform of FIG. 5, a long reset period is required due to the slope restriction of the ramp waveform, since the wall charge is controlled by preventing a strong discharge by decreasing the voltage of the scan electrode gently. However, when strong discharge quenching by floating is used, the voltage of the scan electrode can fall rapidly as shown in FIG. 12A and FIG. 12B, and thus the reset period can be reduced.

Further, the exemplary embodiment of the present invention discloses that the address discharge occurs at the discharge cell being turned on in the address period, and the wall charge is formed at the discharge cell being turned on by the address discharge. However, the address discharge may occur at the discharge cell that is not turned on, and the wall charge is quenched at the discharge cell that is not turned on.

As such, according to the present invention, the address discharge occurs at a discharge cell being turned on in some subfield, and the discharge for reset occurs at the same time. Thus, the reset period including a rising waveform and a falling waveform can be removed in some subfields. Further, emission does not occur at the screen of 0 gray (black gray), since the reset discharge does not occur at the discharge cell that is not turned on. Thus, the hazy black screen can be prevented.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A driving method of a plasma display panel, the plasma display panel having a plurality of first electrodes arranged in one direction and plurality of second electrodes arranged in a direction crossed with the first electrodes, and discharge cells formed at each cross area of the first electrodes and the second electrodes, comprising:
applying a second voltage to the first electrode being selected in an order in which the plurality of first electrodes are selected, the second voltage being higher than a first voltage being applied to other first electrodes in a subfield of a first group of subfields; and
applying a fourth voltage to the second electrode of a discharge cell being turned on among a plurality of discharge cells located in the first electrodes, the fourth voltage being lower than a third voltage being applied to other second electrodes, and selecting the discharge cell being turned on in the subfield of the first group of subfields; and
performing sustain discharge at the selected discharge cell in the subfield.

2. The driving method of the plasma display panel of claim 1, wherein an electric field occurs between the first electrode and the second electrode in a direction from the first electrode to the second electrode, and wherein discharge occurs in the electric field.

3. The driving method of the plasma display panel of claim 1, wherein one field comprises the first group of subfields and a second group of subfields, and the first group of subfields and the second group of subfields are determined by voltage applied for selecting the discharge cell being turned on, further comprising:
applying a sixth voltage to the first electrode being selected in an order in which the plurality of first electrodes are selected, the sixth voltage being lower than a fifth voltage being applied to other first electrodes;
applying an eighth voltage to the second electrodes of a discharge cell being turned on among plurality of discharge cells located in the first electrodes, the eighth voltage being higher than a seventh voltage being applied to other second electrodes;
selecting a discharge cell being turned on in a subfield of the second group of subfields; and
performing sustain discharge at the selected discharge cell in the subfield.

4. The driving method of the plasma display panel of claim 3, wherein the plasma display panel is arranged in the same direction as the first electrodes, and further comprises a plurality of third electrodes forming the discharge cells with the first electrodes and the second electrodes; and
a first sustain discharge among the sustain discharges in the subfield of the first group of subfields is fired by applying a ninth voltage to the first electrode and applying a tenth voltage to the third electrode, the tenth voltage being higher than the ninth voltage.

5. The driving method of the plasma display panel of claim 4, wherein the first sustain discharge among the sustain discharges in the subfield of the second group of subfields is fired by applying an eleventh voltage to the first electrode and applying a twelfth voltage to the third electrode, the twelfth voltage being lower than the eleventh voltage.

6. The driving method of the plasma display panel of claim 1, further comprising erasing a wall charge formed by sustain discharge in the previous subfield and selecting the discharge cell in the subfield of the first group of subfields.

7. The driving method of the plasma display panel of claim 1, further comprising gradually reducing the voltage of the first electrode from the ninth voltage to the tenth voltage and selecting the discharge cell in the subfield of the first group of subfields.

8. The driving method of the plasma display panel of claim 7, wherein the plasma display panel is arranged in the same direction as the first electrodes, and further comprises a plurality of third electrodes forming the discharge cells with the first electrodes and the second electrodes;
the eleventh voltage is the voltage found when the fourth voltage is subtracted from the second voltage, and the twelfth voltage is the voltage found when the voltage being applied to the second electrode is subtracted from the tenth voltage, when the tenth voltage is applied to the first electrode; and
the difference between the eleventh voltage and the twelfth voltage is more than twice as high as a difference between the voltage being applied to the first electrode and the voltage being applied to the third electrode for a next sustain discharge.

9. The driving method of the plasma display panel of claim 7, wherein the eleventh voltage is the voltage found when the fourth voltage is subtracted from the second voltage, and the twelfth voltage is the voltage found when the voltage being applied to the second electrode is subtracted from the tenth voltage, when the tenth voltage is applied to the first electrode; and
the difference between the eleventh voltage and the twelfth voltage is more than twice as high as a firing voltage between the first electrode and the second electrode.

10. The driving method of the plasma display panel of claim 3, further comprising resetting the discharge cell in which the sustain discharge occurred in the previous subfield and selecting the discharge cell in the subfield of the second group of subfields.

11. The driving method of the plasma display panel of claim 3, further comprising gradually reducing the voltage of the first electrode from the ninth voltage to the tenth voltage and selecting the discharge cell in the subfield of the second group of subfields.

12. The driving method of the plasma display panel of claim 3, wherein the difference between the first electrode and the second electrode is higher than a difference between the fifth voltage and the sixth voltage.

13. The driving method of the plasma display panel of claim 3, wherein the eighth voltage is the same voltage as the third voltage, and the seventh voltage is the same voltage as the fourth voltage.

14. The driving method of the plasma display panel of claim 1, wherein the first voltage is a highest voltage among the voltages being applied to the first electrode in the subfield of the first group of subfields.

15. The driving method of the plasma display panel of claim 1, wherein the first subfield in one field is in the first group of subfields.

16. The driving method of the plasma display panel of claim 1, wherein the subfield of the first group of subfields in one field is the subfield with low weight.

17. The driving method of the plasma display panel of claim 1, wherein the discharge cell is turned on in the subfield of the first group of subfields, when the discharge cell is turned on at least one time in one field.

18. The driving method of the plasma display panel of claim 1, wherein at least one subfield in one field are the subfields of the first group of subfields when a gray of the field is 0.

19. A plasma display device comprising:
a plasma display panel having a plurality of first electrodes arranged in one direction and plurality of second electrodes arranged in a direction crossed with the first electrodes, and discharge cells formed at each cross area of the first electrodes and the second electrodes;
a first driver for applying a selected voltage to a first electrode being selected in an order in which a plurality of first electrodes are selected;
a second driver for applying a driving voltage to a plurality of second electrodes, and selecting a discharge cell being turned on with the first electrode to which the selected voltage is applied;
wherein the selected voltage is a highest voltage among the voltages being applied to the first electrode in the subfield of the first group of subfields.

20. The plasma display device of claim 19, wherein a first voltage, the first voltage being a selected voltage in the subfield, is applied to the first electrode, while a second voltage lower than the first voltage is applied to the other first electrodes.

21. The plasma display device of claim 20, wherein the second driver applies a fourth voltage that is lower than a third voltage to the second electrode located on the discharge cell being turned on among the plurality of the second electrodes, the third voltage being applied to the other second electrodes; and
an electric field is formed from the first electrode to the second electrode and discharge occurs thereto so that the discharge cell is selected.

22. The plasma display device of claim 21, wherein one field comprises a first group of subfields and a second group of subfields, and the first group and the second group are determined by voltage being applied at the time for selecting the discharge cell being turned on; and
a fifth voltage, the fifth voltage being a selected voltage, is applied to the first electrode, while the sixth voltage higher than a fifth voltage is applied to the other first electrodes in the subfield of the second group of subfields.

23. The plasma display device of claim 22, wherein in the subfield of the second group of subfields, the second driver applies an eighth voltage higher than a seventh voltage to the second electrode located on the discharge cell being turned on among the plurality of the second electrodes, the seventh voltage being applied to the other second electrodes so that the discharge cell is selected.

24. The plasma display device of claim 19, wherein the plasma display panel further comprises a plurality of third electrodes arranged corresponding to the first electrode, the plurality of third electrodes forming the discharge cells with the first electrodes and the second electrodes; and
the voltage for sustain discharge is applied to the first electrode and the third electrode of the discharge cell selected and the sustain discharge is performed at the selected discharge cell.

25. A plasma display device comprising:
a plasma display panel having a plurality of first electrodes arranged in one direction and a plurality of second electrodes arranged in a direction crossed with the first electrodes, and discharge cells formed at each cross area of the first electrodes and the second electrodes;
a first driver for alternatively applying a first voltage and a second voltage to the first electrode; and
a second driver for applying a third voltage that is higher than the first voltage to the second electrode, while the first voltage is applied to the first electrode, and for applying a fourth voltage that is lower than the second voltage to the second electrode, while the second voltage is applied to the first electrode, and for performing sustain discharge at the selected discharge cell among the discharge cells,
wherein a first sustain discharge occurs by the first voltage and the third voltage in the subfield of the first group of the subfields, and the first sustain discharge occurs by the second voltage and the fourth voltage in the subfield of the second group of the subfields.

26. The plasma display device of claim 25, wherein the first driver applies a selected voltage to the first electrode being desired to select among the plurality of the first electrodes; and
the plasma display device further comprises a third driver for applying an address voltage to the third electrode located on the discharge cell being turned on among the plurality of third electrodes, while the selected voltage is applied to the first electrode, and selects the discharge cell.

27. The plasma display device of claim 26, wherein the selected voltage is higher than the address voltage in the subfield of the first group of subfields and the selected voltage is lower than the address voltage in the subfield of the second group of subfields.

28. The plasma display device of claim 27, wherein the second driver applies a voltage lower than the selected voltage to the second electrode while the selected voltage is applied to the first electrode in the subfield of the first group of subfields; and
the second driver applies a voltage higher than the selected voltage to the second electrode, while the selected voltage is applied to the first electrode in the subfield of the second group of subfields.

29. The plasma display device of claim 26, wherein the selected voltage is a highest voltage among the voltages being applied to the first electrode in the subfield of the first group of subfields.

30. The plasma display device of claim 26, wherein the first driver gradually reduces the voltage of the first electrode to the fifth voltage after the sustain discharge is finished in the previous subfield; and
the difference between the selected voltage and the fifth voltage is more than twice as high as the difference between the first voltage and the third voltage in the subfield of the first group of subfields.

31. The plasma display device of claim 26, wherein the first driver gradually reduces the voltage of the first electrode to the fifth voltage after the sustain discharge is finished in the previous subfield; and
the difference between the selected voltage and the fifth voltage is more than twice as high as a firing voltage between the first electrode and the third electrode in the subfield of the first group of subfields.

32. A plasma display device comprising:
a plasma display panel where plurality of discharge cells are formed, and the discharge cells are formed by at least two electrodes; and
a driver for dividing one field into a plurality of subfields with weights, and applying voltage to the electrodes in each subfield and displaying gray by discharging the discharge cells;
wherein the discharge occurs at only a discharge cell being turned on in at least one field such that the wall charge formed in the previous field is quenched.

33. The plasma display device of claim 32, wherein one subfield is composed of a first period for resetting a discharge cell, a second period for selecting the discharge cell being turned on, and a third period for performing sustain discharge at the selected discharge cell; and
the driver operates the first period and the second period in at least one subfield.

34. The plasma display device of claim 33, wherein only a discharge cell being turned on is reset, while the first period and the second period are operated at the same time.

35. The plasma display device of claim 33, wherein the driver resets only a discharge cell in at least one subfield, the discharge cell being sustain discharged in the previous subfield.

36. A plasma display device comprising:
a plasma display panel where a plurality of discharge cells are formed, and each discharge cell is formed by at least two electrodes; and
a driver for dividing one field into a plurality of subfields with weights, and applying voltage to the electrodes in each subfield and displaying a gray by discharging the discharge cell,
wherein the driver selects the discharge cell being turned on in at least one subfield and resets only the discharge cell being turned.
